(19) United States
(12) Patent Application Publication
(10) Pub. No.: US 2005/0198496 A1
(43) Pub. Date: Sep. 8, 2005

(54) Method, electronic device, computer program product of determining a protection domain

(75) Inventor: Krishnan Vaidyanathan, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/795,210

(22) Filed: Mar. 4, 2004

(51) Int. Cl. H04L 9/00

(52) U.S. Cl. 713/157

(57) ABSTRACT

A java implementation on an electronic device determines into which protection domain a downloaded java application belongs based on a root certificate to which the application was authenticated. The MIDP 2.0 specification says that manufacturer and trusted third party domain root certificates can exist on the device. If they both exist in the device there is no way presented in the specification how to distinguish them. So once the authentication is successful, the java implementation does not know into which domain the application belongs, because it does not know which root certificate is meant for the manufacturer domain and which root certificate is meant for the trusted third party domain. The invention discloses a solution in which at least one root certificate file attribute is used to determine whether the certificate is a manufacturer or trusted third party domain certificate. If the root certificate is read-only, the java application is assigned to the manufacturer domain.

### BACKGROUND OF THE INVENTION

1. Field of the Invention

The present invention relates to terminal devices. In particular, the present invention relates to a novel and improved method, electronic device and computer program product of assigning a signed java application to a protection domain in an electronic device.

2. Description of the Related Art

Most mobile terminals, e.g. mobile phones, comprise the Java 2 Platform, Micro Edition (J2ME). The J2ME platform consists of the Mobile Information Device Profile (MIDP) and Connected, Limited Device Configuration (CLDC) platforms. The MIDP platform is based on a standard that is created in a standardization group known as the JCP (see e.g. www.jcp.org) The latest java platform for mobile devices is based on a standard called MIDP 2.0.

The goal of the MIDP is to create an open, third-party application development environment for Mobile Information Devices (MIDs). FIG. 1 describes briefly the High-Level Architecture for the MIDs. Not all devices that implement the MIDP specification will have all the elements shown in FIG. 1, nor will every device necessarily layer its software as depicted in FIG. 1.

In the High-Level Architecture, the lowest-level block (MID) represents the Mobile Information Device hardware. On top of this hardware is the native system software. This layer includes the operating system and libraries used by the device.

Starting at the next level, from left to right, is the next layer of software, the CLDC. This block represents the Virtual Machine and associated libraries defined by the CLDC specification. This block provides the underlying Java functionality upon which higher-level Java Application Program Interfaces (API) may be built.

Two categories of APIs are shown on top of the CLDC:
MIDP APIs: The set of APIs defined in this specification.
OEM-specific APIs: Given the broad diversity of devices in the MIDP space, it is not possible to fully address all device requirements. These classes may be provided by an OEM to access certain functionality specific to a given device. These applications may not be portable to other MIDs.

Note that in FIG. 1, the CLDC is shown as the basis of the MIDP and device-specific APIs. This does not imply that these APIs cannot have native functionality (i.e., methods declared as native). Rather, the intent of FIG. 1 is to show that any native methods on a MID are actually part of the virtual machine, which maps the Java-level APIs to the underlying native implementation.

The top-most blocks in FIG. 1 represent the application types possible on a MID. In the following a short description of each application is disclosed:
MIDP: A MIDP application, or MIDlet, is one that uses only the APIs defined by the MIDP and CLDC specifications. This type of application is the focus of the MIDP specification and is expected to be the most common type of application on a MID.
OEM-Specific: An OEM-specific application depends on classes that are not part of the MIDP specification (i.e., the OEM-specific classes). These applications are not portable across MIDs.
Native: A native application is one that is not written in Java programming language and is built on top of the MID's existing, native system software.

Security for trusted MIDlet suites is based on protection domains. Each protection domain defines the permissions that may be granted to a MIDlet suite in that domain. The protection domain owner specifies how the device identifies and verifies that it can trust a MIDlet suite and bind it to a protection domain with the permissions that authorize access to protected APIs or functions. The mechanisms the device uses to identify and trust MIDlet suites are defined separately to allow them to be selected appropriately to the device, network, and business case.

In the MIDP 2.0 specification the different MIDlet suites are categorized to different protection domains—operator domain, manufacturer domain, trusted third party domain and untrusted domain. All, except untrusted domain MIDlet suites are digitally signed through a system of PKI (X.509 Public Key Infrastructure) and root certificates (a certificate associated with a protection domain that the device implicitly trusts to verify and authorize downloaded MIDlet suites).

Once a java application is downloaded to the mobile terminal, the java implementation on the mobile terminal determines into which category the application belongs. This happens through a system of PKI and root certificates. The java application has previously been signed, and the signed application is authenticated to a root certificate on the mobile terminal. The MIDlet suite is protected by signing the Java archive (JAR) file. The signature and intermediate certificates excluding the root certificate are added to the application descriptor as attributes. Once the authentication is successful, the java implementation decides to categorize the application into a domain based on the root certificate to which the application was authenticated.

The MIDP 2.0 specification states that manufacturer and trusted third party domain root certificates can exist on the device. Once the authentication is successful, the java implementation does not know into which domain the application belongs because it does not know which root certificate is meant for the manufacturer domain and which root certificate is meant for the trusted third party domain. The reason behind this is that the X.509 specification that defines what root certificates should look like and what fields it contains etc. does not say anything about java domains. With other certificates, operator and untrusted domain root certificates, one does not have the same problem because an operator domain root certificate is located in specified location in the Subscriber identity module (SIM), UMTS Subscriber Identity Module (USIM) or Wireless Identity Module (WIM). And untrusted domain MIDlet suites are those that are not signed, so they are not authenticated when installing.

Therefore, there exists a need for a mechanism that tells the java implementation whether a particular root certificate is a manufacturer root certificate or a trusted third party domain root certificate.

### SUMMARY OF THE INVENTION

The invention discloses a solution with which a java application can unambiguously be authenticated to a manufacturer domain or trusted third party domain.

In particular, according to one aspect of the invention there is provided a method of assigning a signed application to a protection domain in an electronic device. In the method, at least one root certificate is stored on a memory of an electronic device. The root certificates may comprise at least one of a manufacturer domain certificate and a trusted third party domain certificate. When a signed application is received with the electronic device, the application is authenticated to a root certificate stored on the memory of the electronic device by verifying a signer certificate and an application signature. The signed application is e.g. a signed java application.

After authentication the java implementation has to determine to which protection domain the authenticated java application belongs. The determination is based on the fact that each root certificate file has certain file attributes. One file attribute tells whether a root certificate is read-only. The java implementation determines based on at least one file attribute of the root certificate used in the authenticating step whether the root certificate is a manufacturer domain certificate or a trusted third party certificate. If the at least one file attribute indicates that the root certificate is read-only, the authenticated java application is assigned to a manufacturer domain. Correspondingly, If the at least one file attribute indicates that the root certificate is not read-only, i.e. it can be deleted, the authenticated java application is assigned to a trusted third party domain.

According to another aspect of the invention there is provided a computer program product of assigning a signed application to a protection domain in an electronic device, comprising code stored on at least one data-processing device readable medium. The code is adapted to perform the following steps when executed on a data-processing device: storing on a memory of an electronic device at least one root certificate, receiving a signed application with the electronic device, authenticating the signed java application to a root certificate stored on the electronic device by verifying a signer certificate and an application signature, determining based on at least one file attribute of the root certificate whether the root certificate is a manufacturer domain certificate or a trusted third party domain certificate, and assigning the signed application to a respective protection domain. The signed application is e.g. a signed java application.

In one embodiment, the computer program product further comprises code stored on at least one data-processing device readable medium, the code being adapted to perform the following steps when executed on the data-processing device: determining whether the root certificate is a read-only certificate based on the at least one file attribute of the root certificate; and if it is read-only, assigning the signed application to a manufacturer domain.

In one embodiment, the computer program product further comprises code stored on at least one data-processing device readable medium, the code being adapted to perform the following steps when executed on the data-processing device: determining whether the root certificate can be deleted based on the at least one file attribute of the root certificate; and if it can be deleted, assigning the signed application to a trusted third party domain.

According to yet another aspect of the invention there is provided an electronic device for assigning a signed application to a protection domain, wherein the electronic device comprises: a memory configured to store at least one root certificate, receiving means configured to receive a signed application with the electronic device, authenticating means configured to authenticate the signed java application to a root certificate stored on the memory by verifying a signer certificate and an application signature, determining means configured to determine based on at least one file attribute of the root certificate whether the root certificate is a manufacturer domain certificate or a trusted third party domain certificate, and assigning means configured to assign the signed application to a respective protection domain. The signed application is e.g. a signed java application.

In one embodiment of the invention the determining means are configured to determine whether the root certificate is a read-only certificate based on the at least one file attribute of the root certificate; and if it is read-only, the assigning means are configured to assign the signed application to a manufacturer domain.

In one embodiment of the invention the determining means are configured to determine whether the root certificate can be deleted based on the at least one file attribute of the root certificate; and if it can be deleted, the assigning means are configured to assign the signed application to a trusted third party domain.

In one embodiment of the invention the root certificate is based on X.509 Public Key Infrastructure.

According to yet another aspect of the invention there is provided an electronic device of assigning a signed application to a protection domain, wherein the electronic device comprises a memory configured to store at least one root certificate, a receiver configured to receive a signed application with the electronic device, a central processing unit configured to authenticate the signed java application to a root certificate stored on the memory by verifying a signer certificate and an application signature, to determine based on at least one file attribute of the root certificate whether the root certificate is a manufacturer domain certificate or a trusted third party domain certificate; and to assign the signed application to a respective protection domain. The signed application is e.g. a signed java application.

In one embodiment of the invention the central processing unit is configured to determine whether the root certificate is a read-only certificate based on the at least one file attribute of the root certificate; and if it is read-only, the central processing unit is configured to assign the signed application to a manufacturer domain.

In one embodiment of the invention the central processing unit is configured to determine whether the root certificate can be deleted based on the at least one file attribute of the root certificate, and if it can be deleted, the central processing unit is configured to assign the signed application to a trusted third party domain.

The benefit of the invention is that the java implementation of the electronic device knows into which category (manufacturer or trusted third party domain) the java application belongs.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 (PRIOR ART) is a high-level architecture view for MIDP implementers and developers,

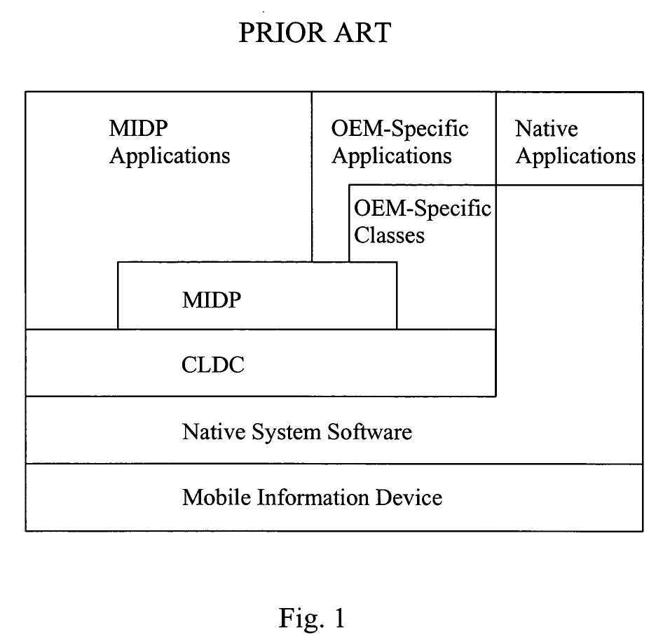

FIG. 2 is a flow chart illustrating one embodiment of the method according to the invention, and

FIG. 3 is a block diagram illustrating one embodiment of an electronic device according to the invention.

### DETAILED DESCRIPTION OF THE PREFERRED EMBODIMENTS

Reference will now be made in detail to the embodiments of the present invention, examples of which are illustrated in the accompanying drawings.

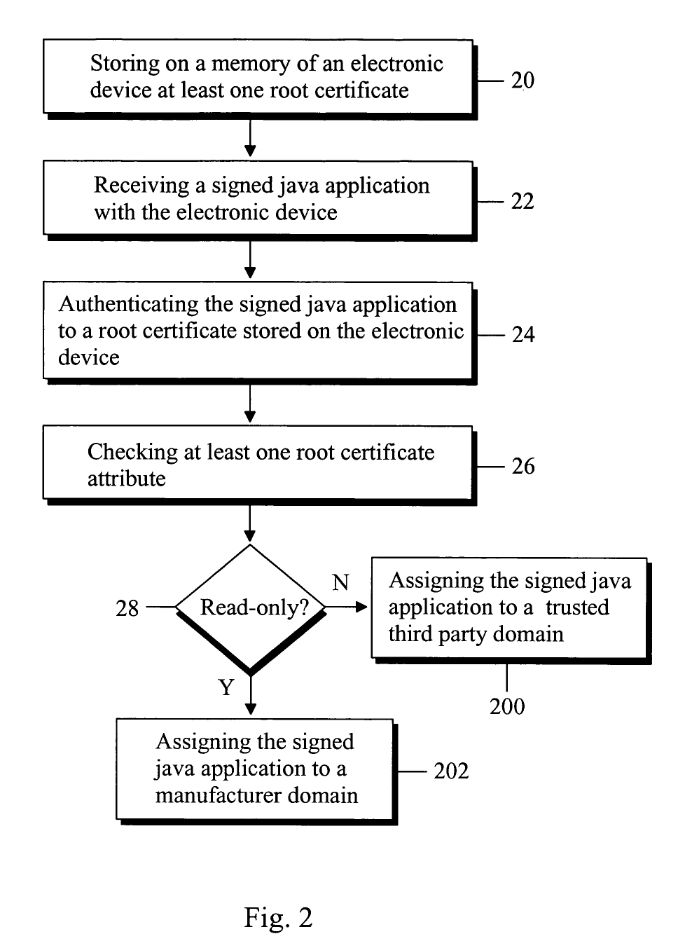

FIG. 2 is a flow chart illustrating one embodiment of the method according to the invention. In the method, an electronic device, e.g. a mobile phone, a personal digital assistant, a computer etc., stores on a memory at least one root certificate, as illustrated at step 20. The term ‘root certificate’ refers to a certificate with which a java application is authenticated to a protection domain.

The MIDP 2.0 specification says that manufacturer and trusted third party domain root certificates can exist on the electronic device. If they both exist in the device there is no way presented in the specification how to distinguish those. So once the authentication is successful, the java implementation does not know into which domain the java application belongs, because it does not know which root certificate is meant for the manufacturer domain and which root certificate is meant for the trusted third party domain.

When the electronic device receives a signed java application (step 22), it authenticates the signed java application to a root certificate stored on the memory by verifying a signer certificate and an application signature, as illustrated at step 24. A more detailed description of the authenticating step can be found e.g. in the MIDP 2.0 specification. As is known from Public Key Infrastructure, there will be at a maximum one root certificate to which the signed java application is authenticated. If the manufacturer protection domain root certificate is not available on the electronic device, the manufacturer domain must be disabled. The actual verification of a signed certificate and the verification of the MIDP application suite java archive file (JAR file) is not described here in more detain. A more detailed description can be found in the MIDP 2.0 specification.

The java implementation determines based on at least one file attribute of the root certificate whether the root certificate is a manufacturer domain certificate or a trusted third party domain certificate, as illustrated at step 26. If the determining step indicates that the root certificate is read-only, the root certificate is meant for the manufacturer domain, as illustrated at steps 28 and 202. Correspondingly, if the determining step indicates that the root certificate can be deleted, the root certificate is meant for the trusted third party domain, as illustrated at steps 28 and 200.

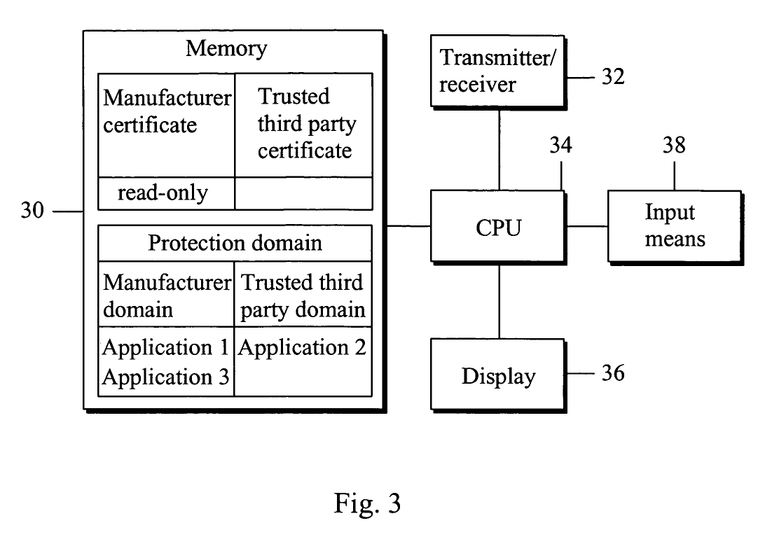

FIG. 3 is a block diagram illustrating one embodiment of an electronic device according to the invention. FIG. 3 discloses a greatly simplified block diagram of an electronic device that implements at least part of the MIDP 2.0 specification. It is clear that the electronic device may comprise also other elements and components not disclosed in FIG. 3. The electronic device is e.g. a mobile phone, a computer or a personal digital assistant.

The electronic device comprises a central processing unit 34 that is connected to a memory 30, a transmitter/receiver 32, a display 36 and input means 38. Input means 38, e.g. a keypad, and display 36 function together so that input means 38 provide input from a user of the electronic device e.g. in response to information displayed on display 36.

Memory 30 may comprise one or more root certificates for authentication purposes. In FIG. 3 it is disclosed that both manufacturer domain root certificate and trusted third party domain root certificate are stored on memory 30. If the manufacturer protection domain root certificate is not available on the electronic device, the manufacturer domain must be disabled.

When a signed java application is received with receiver 32, the central processing unit 34 functioning together with memory 30 authenticates the signed java application to one of the root certificates stored on memory 30. Each certificate file has at least one file attribute, namely, e.g. whether a certificate is a read-only certificate or not. The MIDP 2.0 specification states that the manufacturer protection domain root certificate can only be deleted or modified by the manufacturer. Furthermore, it is further stated in the MIDP 2.0 specification that the user must be able to delete or disable trusted third party protection domain root certificates. Therefore, a manufacturer domain root certificate is read-only and trusted third party domain is not.

Central processing unit 34 determines from memory 30 whether the root certificate to which the application was authenticated is read-only. The determination is based on at least one file attribute of the root certificate. If the root certificate is read-only, the root certificate is a manufacturer domain root certificate. Otherwise it is a trusted third party domain root certificate.

FIG. 3 discloses three applications from which two have been authenticated to the manufacturer domain and one to the trusted third party domain.

FIG. 3 illustrates a single memory 30. Memory 30 may refer to a single memory or memory area or to a plurality memories or memory areas that may include e.g. random access memories (RAM), read-only memories (ROM) etc. Memory 30 may also include other applications or software components that are not described in more detail and also may include the computer program (or portion thereof), which when executed on central processing unit 34 performs at least some of the steps disclosed in the invention. Central processing unit 34 may also include memory or a memory may be associated therewith which may include the computer program (or portion thereof) which when executed on central processing unit 34 performs at least some of the steps disclosed in the invention.

The invention discloses a signed java application as an example for signed applications. It is evident to a person skilled in the art that the signed application may also refer to an application of a different programming language.

It will be evident to a person skilled in the art that with the advancement of technology, the basic idea of the invention may be implemented in various ways. The invention and its embodiments are thus not limited to the examples described above, instead they may vary within the scope of the claims.

1. A method of assigning a signed application to a protection domain in an electronic device, the method comprising:
storing on a memory of an electronic device at least one root certificate;
receiving a signed application with the electronic device;
authenticating the signed application to a root certificate stored on the electronic device by verifying a signer certificate and an application signature;
determining based on at least one file attribute of the root certificate whether the root certificate is a manufacturer domain certificate or a trusted third party domain certificate; and
assigning the signed application to a respective protection domain.

2. The method according to claim 1, further comprising:
determining whether the root certificate is a read-only certificate based on the at least one file attribute of the root certificate; and if it is read-only,
assigning the signed application to a manufacturer domain.

3. The method according to claim 1, further comprising:
determining whether the root certificate can be deleted based on the at least one file attribute of the root certificate; and if it can be deleted,
assigning the signed application to a trusted third party domain.

4. The method according to claim 1, wherein the root certificate is based on X.509 Public Key Infrastructure.

5. A computer program product of assigning a signed application to a protection domain in an electronic device, comprising code stored on at least one data-processing device readable medium, the code adapted to perform the following steps when executed on a data-processing device:
storing on a memory of an electronic device at least one root certificate;
receiving a signed application with the electronic device;
authenticating the signed application to a root certificate stored on the electronic device by verifying a signer certificate and an application signature;
determining based on at least one file attribute of the root certificate whether the root certificate is a manufacturer domain certificate or a trusted third party domain certificate; and
assigning the signed application to a respective protection domain.

6. The computer program product according to claim 5, further comprising code stored on at least one data-processing device readable medium, the code adapted to perform the following steps when executed on the data-processing device:
determining whether the root certificate is a read-only certificate based on the at least one file attribute of the root certificate; and if it is read-only,
assigning the signed application to a manufacturer domain.

7. The computer program product according to claim 5, further comprising code stored on at least one data-processing device readable medium, the code adapted to perform the following steps when executed on the data-processing device:
determining whether the root certificate can be deleted based on the at least one file attribute of the root certificate; and if it can be deleted,
assigning the signed application to a trusted third party domain.

8. The computer program product according to claim 5, wherein the root certificate is based on X.509 Public Key Infrastructure.

9. An electronic device of assigning a signed application to a protection domain, wherein the electronic device comprises:
a memory configured to store at least one root certificate;
receiving means configured to receive a signed application with the electronic device;
authenticating means configured to authenticate the signed application to a root certificate stored on the memory by verifying a signer certificate and an application signature;
determining means configured to determine based on at least one file attribute of the root certificate whether the root certificate is a manufacturer domain certificate or a trusted third party domain certificate; and
assigning means configured to assign the signed application to a respective protection domain.

10. The electronic device according to claim 9, wherein:
the determining means are configured to determined whether the root certificate is a read-only certificate based on the at least one file attribute of the root certificate; and if it is read-only, the assigning means are configured to assign the signed application to a manufacturer domain.

11. The electronic device according to claim 9, wherein:
the determining means are configured to determine whether the root certificate can be deleted based on the at least one file attribute of the root certificate; and if it can be deleted,
the assigning means are configured to assign the signed application to a trusted third party domain.

12. An electronic device of assigning a signed application to a protection domain, wherein the electronic device comprises:
a memory configured to store at least one root certificate;
a receiver configured to receive a signed application with the electronic device;
a central processing unit configured to authenticate the signed application to a root certificate stored on the memory by verifying a signer certificate and an application signature, to determine based on at least one file attribute of the root certificate whether the root certificate is a manufacturer domain certificate or a trusted third party domain certificate, and to assign the signed application to a respective protection domain.

13. The electronic device according to claim 12, wherein:
the central processing unit is configured to determined whether the root certificate is a read-only certificate based on the at least one file attribute of the root certificate; and if it is read-only,
the central processing unit is configured to assign the signed application to a manufacturer domain.

14. The electronic device according to claim 12, wherein:
the central processing unit is configured to determine whether the root certificate can be deleted based on the at least one file attribute of the root certificate; and if it can be deleted,
the central processing unit is configured to assign the signed application to a trusted third party domain.

15. The electronic device according to claim 12, wherein the root certificate is based on X.509 Public Key Infrastructure.

16. The electronic device according to claim 12, wherein the electronic device comprises at least one of a mobile phone, a personal digital assistant and a computer.
